(19) United States
(12) Patent Application Publication
(10) Pub. No.: US 2026/0316119 A1
(43) Pub. Date: Oct. 15, 2026

(54) SYSTEM FOR SORTING MAIL ITEMS AND METHOD FOR SORTING MAIL ITEMS

(71) Applicant: Körber Supply Chain Logistics GmbH, Konstanz (DE)

(72) Inventor: Marco Fischer, Konstanz (DE)

(21) Appl. No.: 19/485,120

(22) PCT Filed: Mar. 25, 2024
(86) PCT No.: PCT/EP2024/057954

§ 371 Date: Nov. 17, 2025

(30) Foreign Application Priority Data
May 19, 2023 (DE) 10 2023 113 158.3

(51) Int. Cl. B07C 3/02; B07C 5/16; B07C 5/36

(52) U.S. Cl. CPC B07C 3/02; B07C 5/165; B07C 5/36; B07C 2501/0063

(57) ABSTRACT

A system for sorting mail items includes an input area at which mail items can be fed to the system, a buffer area configured to temporarily store at least one mail item, at least one output area via which the mail items can be output from the system, a gripping device configured to feed mail items in a gripping area of the gripping device from the input area to the buffer area and/or the output area, and a control unit configured to control the gripping device such that the at least one mail item is provided at the output area on the basis of at least one mail item information. A method for sorting mail items is also provided.

### BACKGROUND

It is known in the prior art that letters can be sorted and delivered by machine in a delivery sequence. The sequence is the order in which the letters are delivered to the respective recipient during a delivery driver's departure on a predetermined route. Larger consignments are currently pre-sorted by hand so that the deliverer has an efficient delivery journey and little time lost en route. As a result, a lot of time is required in the mail center or parcel center to manually sort the mail items, that cannot be provided by machine in an aisle sequence, into the appropriate aisle sequence. This is usually done by the deliverer themselves, so that a large part of their working time is not spent on the delivery itself, but on preparing it.

It is therefore an object of the present invention to provide a solution that can make a delivery journey more efficient.

### SUMMARY OF THE INVENTION

According to one aspect of the present invention, a system for sorting mail items is provided. The system can comprise an input area at which mail items can be fed to the system. Further, the system may comprise a buffer area designed to temporarily store at least one mail item. Furthermore, the system can comprise at least one output area via which the mail items can be output from the system. A gripping device may be provided, which is designed to feed mail items in a gripping area of the gripping device from the input area, the buffer area and/or the output area. Furthermore, the system may comprise a control unit designed to control the gripping device such that the at least one mail item can be provided at the output area based on at least one mail item information.

Compared to the known prior art, the present invention offers the advantage that the system can also sort larger mail items, such as smalls or parcels, fully automatically in order to prepare them in an aisle sequence for a deliverer. This means that sorting of the mail items can begin well before the deliverer starts work, so that sorting is completed as soon as the deliverer starts work. This means that the deliverer can take over the mail items provided at the delivery area directly and start their route (e.g. the delivery journey). This enables efficient delivery. Furthermore, an increasing volume of mail items is to be expected in the future, which cannot be sorted using conventional, mechanical aisle sorting systems. Furthermore, such a system can also be used in a delivery base for other tasks, such as the identification of mail items or rough sorting to a small number of terminals. The system can also be used to prepare mail items for automated delivery. The gripping device can be designed to feed mail items from the input area directly to the buffer area or the output area. In other words, a mail item does not have to be transported through any device first. Similarly, the gripping device can be designed to feed a mail item directly from the buffer area to the output area. In summary, a single (i.e. exclusively one) gripping device can be provided which can feed mail items from the input area to the buffer area and the output area. Preferably, only a single buffer area may be provided. In other words, the buffer area can be a single, spatially delimited deposit area on which mail items can be deposited. This can simplify control of the gripping device compared to a case in which the gripping device would have to feed the mail items to a large number of buffer areas. For example, the buffer area cannot be designed as an AGV or similar, as this would considerably increase the complexity of the overall system. In contrast, the output area can be realized with AGVs in some embodiments.

The input area can, for example, be a staging area where mail items are staged automatically or manually. For example, the input area can be a table-like element on which mail items can be delivered and deposited. The input area can be an area in which mail items can be provided in a terminal-like manner. In other words, the mail items can stand still in the input area in a gripping state. This means that the mail items can be conveyed to the input area and wait there for further handling by the gripping device. This waiting can be referred to as the gripping state. This means that the input area cannot be a circular conveyor or similar. As a result, the gripping process of the mail item can be simplified compared to an input area in which the mail items are conveyed permanently and relative to the gripping device. For example, the input area can be driven intermittently, so that a piece good positioned on the input area is only moved intermittently. In other words, the input area can only move the piece good when no gripping process (i.e. gripping of the piece good by the gripping device) is in progress. The buffer area can be a table-like element on which at least one mail item, preferably a plurality of mail items, can be deposited. In particular, the buffer area has a larger surface area than the input area. In the present case, the surface can mean a depositing surface on which piece goods can be deposited. Preferably, the buffer area is at least twice, preferably at least five times, as large as the input area. This offers the advantage that the mail items in the input area can be stacked or provided in a transport container, for example, whereas the mail items in the buffer area can be arranged next to each other in a horizontal plane. In other words, the mail items can be placed in the buffer area in such a way that they can be gripped individually. This offers the advantage that, while the mail items can only be removed from the input area from a staggered position one after the other (i.e. in a predetermined sequence, which may not correspond to the aisle sequence of a deliverer), the mail items can be specifically selected from the buffer area and transported away by the gripping device. In other words, the removal from the input area depends on which mail item can be gripped first (for example, if the mail items are stacked), whereas certain mail items can be specifically selected from the buffer area and removed accordingly. The gripping device can be a device that can individually grip and transport a single mail item. Preferably, the gripping device has a first movement in which the gripping device transfers a mail item from the input area to the output area (for example, when the mail item is provided at the input area in the desired order). The gripping device can have a second movement in which the gripping device transfers a mail item from the input area to the buffer area. Furthermore, the gripping device can have a third movement in which the gripping device transfers a mail item from the buffer area to the output area. The output area can be designed identically to the input area. The output area can be separate from the input area. A mail item can be transferred from the input area to the output area exclusively by means of the gripping device. In other words, the output area can also be a table-like structure. Additionally or alternatively, the output area can have a conveyor belt so that mail items deposited there can be transported automatically. Furthermore, at least one transport box can be provided at the output area, into which the mail items can be placed by the gripping device. The output area can have one or more end points into which the mail items can be sorted. The gripping device can be designed to feed the mail items directly or indirectly from the input area to the output area based on at least one mail item information. The mail item information can be indicative of the position in the aisle sequence of a deliverer. In other words, the mail item information can be used to determine the position of the respective mail item in the aisle sequence to be sorted. Consequently, the gripping device can transport a mail item directly from the input area to the output area (first movement) if the mail item provided at the input area can be sorted directly into the aisle sequence. However, if the mail item that can next be gripped by the gripping device from the input area cannot be transferred directly to the output area because it does not fit into the position in the aisle sequence that is now to be sorted, the gripping device can transfer the mail item from the input area to the buffer area (second movement). When it is the turn of this mail item, which is then temporarily stored in the buffer area, to be sorted to the next position in the aisle sequence, the gripper can feed the mail item from the buffer area to the output area (third movement). This can provide an automated sorting system that can automatically sort even larger mail items, such as smalls or parcels, into a corresponding aisle sequence. The gripping device can comprise a mechanical gripper or a pneumatic gripper. More specifically, the gripper can be a suction gripper that can suck in and transport a mail item by means of negative pressure. Alternatively, the gripping device can be a mechanical gripper that can grip and transport the mail item by means of a positive connection with the mail item. The gripping device can be designed to grip only a single mail item. In other words, several mail items cannot be gripped simultaneously by the gripping device. The control unit can be a computer-like device that is designed to receive data, process data and output data, for example in the form of control commands. The control unit can determine or record the mail item information of the mail item provided at the input area. In this way, the control unit can be connected to a higher-level system that provides the control unit with information about the mail items provided at the input area. This means that the system does not necessarily have to have its own recording unit; instead, information about the mail item that has already been recorded in an upstream process can be used. This makes it particularly easy to implement the system in existing systems. Furthermore, the system can also be fed with residual manual sorting. In other words, residual manual sorting can include mail items that have been sorted out from the machine sorting process or ejected due to an error. These are usually sorted manually in the prior art. The gripping device according to one aspect of the invention, which is designed to be able to handle all shapes of mail items, can also handle particularly misshapen mail items or mail items unsuitable for conventional machine processing and sort them accordingly.

The gripping area can be the area in which the gripping device can handle mail items. In other words, the gripping area can represent a radius of action of the gripping device. The gripping area can be defined by a three-dimensional space. In the case where the gripping device has a single attachment point, the gripping area may have the shape of a sphere in three-dimensional space. The input area can, for example, be the area of a conveyor belt that is located in the gripping area of the gripping device. Similarly, the output area can be the area of a conveyor belt, for example, which is located in the gripping area of the gripping device. This means that the system can easily be retrofitted to existing systems. In other words, the input area and/or the output area does not have to be an end point or the like, but can also run through the gripping area. In this case, the gripping device can only handle mail items within the gripping area. Preferably, the gripping device has an attachment point that cannot be moved or displaced during normal operation of the system. The attachment point can be the center of the gripping area. The gripping area is restricted by obstacles that hinder the movement of the gripping device. Such obstacles can be, for example, the floor, other elements, the input area, the buffer area and/or the output area.

Preferably, the output area is designed to provide a transport container into which the at least one mail item can be inserted by the gripping device. The transport container can be a transport box or the like. The mail items can be stacked on top of each other in the transport container. The transport container can be designed to be moved by the deliverer along his delivery route. For example, the transport container can be a box that the deliverer loads into the delivery vehicle. Furthermore, the transport container can also be an automatically movable box, which can be handled by a robot or an automated guided vehicle (AGV). Since the mail items can be stacked on top of each other in the transport container, it is important that the mail items are placed in the transport container in the correct order. As the deliverer wants to remove the mail items according to their aisle sequence, i.e. in the order in which the deliverer arrives at the recipient addresses, it is efficient if the required mail items are placed at the top of the transport container. This can further increase the efficiency of delivery. Preferably, the maximum distance between the boundaries of the gripping area is less than 5 m, preferably less than 3 m. In the case of a spherical gripping area, the distance can be a line that includes two boundaries of the gripping area and the center (in other words, the diameter of the gripping area). In other words, the system can be arranged in a very small space, which makes it particularly easy to implement the system in existing systems.

Preferably, the mail item information comprises a dimension of the mail item, address information of the recipient, weight of the mail item and/or shipping information. The dimension of the mail item can describe the dimensions of the mail item. It can therefore be known how large the respective handled mail item is. This allows the control unit to determine how the mail item is to be handled by the gripping device (for example, where the mail item is best to be gripped and at which position in the buffer area and/or the output area the mail item is to be placed). In this way, space can be used efficiently as, depending on the size of the mail items, they can be handled and placed individually. The address information can be indicative of where the mail item is to be sorted in a deliverer's aisle sequence. The aisle sequences of the respective deliverer can be made available to the control unit. Consequently, the control unit can use the address information of the recipient of the respective mail item to determine at which aisle sequence it is the turn of which mail item. The sequence of mail items created in this way can then be used to determine the order in which the mail items are to be provided at the output area. The dispatch information can, for example, be indicative of whether a mail item is to be sent by cash on delivery, registered mail, registered mail with advice of delivery, etc. Accordingly, the control unit can be designed to provide the mail item at the output area. For example, it is conceivable that at least two sub-areas are defined at the output area, at which mail items with different properties (e.g. dispatch information) can be arranged. In this way, for example, the mail items that are sent with cash on delivery can be arranged in one area and thus loaded separately by the deliverer into the delivery vehicle. This can further increase the efficiency of delivery.

Preferably, the control unit is designed to output position information for the mail item after a mail item has been fed to the output area by the gripping device. The position information can be indicative of where a mail item is located at the output area. For example, it is possible that several sub-areas are defined at the output area. If a mail item is deposited at a sub-area by the gripping device, the control unit can automatically output the position of the deposited mail item. This ensures that the respective mail items can be tracked. Furthermore, this information can be made available to the deliverer so that he knows exactly where which mail item is located. The information can be made available to the deliverer digitally (e.g. on their PDA or similar). This is particularly advantageous if a large number of transportation ratios are provided at the output area, into which the mail items are sorted based on the respective mail item information. This allows the deliverer to determine which mail items are in which container, even without labeling the transport containers. This further simplifies the sorting and acceptance process for the deliverer.

Preferably, the control unit is designed to control the gripping device in such a way that at least one mail item can be sorted out based on mail item information. In other words, the system can also perform a control function. For example, if a mail item is handled by the system which is incorrectly present (i.e. which should normally have been handled somewhere else), the system can sort out this mail item. Furthermore, the system can issue a notification that a mail item has been sorted out. Furthermore, sensors can be provided in the system which can check the handled mail item. This makes it possible to determine whether the properties and/or information of the mail item recorded by the sensors match the properties stored in the respective mail item information. If a deviation is detected, the mail item can be sorted out. It is conceivable here that a weight of the mail item is determined when the mail item is handled and compared with the weight stored in the mail item information. If the mail item actually handled is significantly heavier than the stored weight, the mail item can be sorted out. The sorted out mail items can then be sent for further inspection. Furthermore, unidentified mail items that cannot be assigned a position in the aisle sequence for whatever reason can be sorted out. Sorting can take place in a separate area or space, for example, from which the mail items can be removed for further inspection or transported onwards. This means that even problematic mail items can be handled flexibly without holding up the rest of the operation. This means that the system can be operated efficiently even at peak times (i.e. when the volume of mail items is very high).

Preferably, the system further comprises a recognition system which is designed to recognize at least one mail item in order to obtain recognition information of the mail item. The recognition system may be provided in addition to or as an alternative to the above embodiment. In the above embodiment, the control unit can be supplied with the mail item information of an incoming mail item from a higher-level station (for example, a digitization workstation or the like). The recognition system enables the system itself to detect and/or assign the mail item information of a mail item. The recognition system can be designed to capture identification data of the supplied mail item, which is indicative of mail item information. For example, image recognition can be used here. The image recognition can include an OCR function so that information on the mail item can be read. Accordingly, the recognition system can have access to a database with which the recorded mail item data can be compared. The mail item information can then be deduced from the comparison. Furthermore, the assignment can also be made via a mail item ID, which was created when the mail item was added to the logistics system. Due to the individual recognition system, the system can be located at any point in the logistics process. In other words, in this case the system is not dependent on predetermined mail item information. Consequently, the system can be used more flexibly.

Preferably, the control unit is designed to assign mail item information to a mail item based on the recognition information of the mail item. In other words, the control unit can comprise a comparator unit which is designed to assign the recognition information to mail item information. Here, the control unit can have access to a database.

Preferably, the recognition system is designed to detect the recognition information optically, in particular by means of a barcode on the mail item. In other words, a barcode can be assigned to the mail item in the course of handling by a logistics system and physically affixed to the mail item. This barcode can, for example, be recognized and captured by a camera system in the recognition system. The barcode can represent the recognition information. The respective mail item information can then be assigned to the mail item based on the barcode information. However, a barcode does not have to be provided. Rather, the camera system can also use the OCR function to individually read and record an address or other shipping information on the mail item. Furthermore, the control unit can be designed to automatically create the mail item information (e.g. the shipping information) based on the shipping information read on the mail item. In this case, the control unit itself can store the mail item information in a database. This ensures that the system can be operated as a stand-alone system (i.e. automatically and possibly without a permanent connection to a central database) and/or can check information that has already been recorded. This makes the delivery process more efficient and reliable overall.

Preferably, the buffer area is movable so that it can be displaced relative to the gripping area of the gripping device. In other words, the buffer area does not have to be completely positioned in the gripping area all the time. Rather, it may be sufficient for the position of the buffer area at which a mail item is to be deposited to be positioned in the gripping area at the right time. This solves the problem that the gripping area of a gripping device cannot be extended at will. This means that a significantly larger buffer area can be provided without the gripping device becoming excessively complex and expensive. In this context, displaceable can mean that the buffer area is movable in such a way that only part of it is arranged in the gripping area at any one time. The control can be realized by the control unit. For example, it can be realized in such a way that when the gripping device picks up a mail item from the input area, the control unit determines in parallel to this the target location in the buffer area to which this mail item is to be deposited most efficiently and controls the buffer area accordingly so that the target location is moved into the gripping area for the mail item currently being gripped. If the gripping device with the mail item is pivoted in the direction of the buffer area, the target point for the gripped mail item can already be provided so that the gripping device can deposit the mail item directly in the buffer area without waiting. Similarly, the mail items can also be removed from the buffer area. This means that even large quantities of mail items can be handled with a relatively small gripping area.

Preferably, the buffer area comprises a turntable, a conveyor, a shelf and/or at least one pocket. The turntable offers the advantage that the position of the buffer area at which a mail item is to be deposited or from which a mail item is to be picked up can be moved into the gripping area by turning to the right or left. This enables the target position in the buffer area to be provided quickly, as the shortest path can always be selected. In other words, the area of the buffer area (i.e. the target position) can be brought into the gripping area as quickly as possible. Alternatively, a conveyor such as a conveyor belt or a roller conveyor can be provided, which can be arranged parallel to the input area and the output area, for example. This offers the advantage that a conveyor can be of almost any size, so that even large quantities of mail items can easily be picked up in the buffer area. A shelf can be a three-dimensional structure that can have storage locations arranged one above the other in the direction of gravity (also referred to below as the vertical direction). This means that the gripping device can not only arrange mail items horizontally next to each other, but also vertically on top of each other. Furthermore, this shelf itself can also be designed to be movable so that the gripping area, which can describe a three-dimensional space, can be optimally utilized. A shelf offers the greatest possible efficiency and space utilization, especially when handling so-called small mail items. The pocket can be an expandable device, for example, which can be arranged hanging in the gripping area. Similar to the shelf described above, a pocket can have several vertically stacked storage spaces. The pockets can be selected to be larger or smaller depending on the area of application. This means that the system can be individually equipped and adapted to the respective area of use without significant structural changes.

Preferably, the buffer area can be displaced horizontally and/or vertically with respect to the direction of gravity. As described above, the buffer area can be displaced in at least two directions, regardless of its design. The two displacement directions can be essentially orthogonal to each other. This enables optimum space utilization. A reference to directions is always to be understood as in an operating position of the system.

Preferably, the delivery area comprises at least one automated, driverless vehicle, which is designed to transport at least one mail item. The delivery area can thus also directly comprise a delivery vehicle, so that no further handling of the mail items is necessary after handling by the gripping device. In other words, the gripping device can move the mail items directly into a delivery vehicle. In this case, the delivery area can be located in the delivery vehicle. For example, there are currently concepts that test delivery by means of automated driverless vehicles (e.g. drone, AGV, etc.). Here it is conceivable that the system arranges the mail items directly in such vehicles. The arrangement can be realized based on the mail item information, so that the vehicle has precise knowledge of which mail item is arranged in which position. This allows the logistics process to be further automated.

Preferably, the gripping device can be designed to feed at least one mail item from the buffer area and/or the output area to the input area. In other words, the system can also work backwards. This allows individual consideration to be given to different operating situations. The system can also handle mail items multiple times, for example in cases where the buffer area is not large enough to accommodate all the mail items. This allows the system to carry out pre-sorting, which can then be used as the basis for subsequent sorting. For example, some of the mail items can first be placed in the correct aisle sequence and then returned to the input area. The remaining mail items can then be sorted. The mail items can then be fed to the output area (for example, if a transport box is available). This means that all mail items can be sorted and fed to the output area in a sorted state. This makes it possible to react even more flexibly to different operating conditions. Furthermore, the system can also be operated with a very small buffer area (e.g. where less space is required). Furthermore, the system can also be used efficiently where large quantities of mail items only occur very rarely.

Preferably, the control unit is designed to control the gripping device in such a way that the mail items are sorted according to their dimensions and provided in the buffer area and/or the output area. In this way, the efficiency of the system can be further increased, as particularly large mail items can be arranged at a specific location, while small mail items can be arranged at a different location. As a result, it is not necessary to pass over the area with the large mail items every time only small mail items are to be picked up.

Preferably, the control unit is designed to control the gripping device in such a way that the mail items are provided to an output area in an aisle sequence of a state of the mail items. Here, a system can sort the mail items for one deliverer or for a number of deliverers. For example, different sub-areas can be defined at an output area, each of which is intended for one deliverer. Each deliverer can have a different route and therefore a different aisle sequence. The system can provide the mail items according to an output area in accordance with the respective requirements of the deliverer. This also allows special requirements of each deliverer to be taken into account. For example, one deliverer may be on the road with a motorized vehicle, while another deliverer is on a bicycle and a third deliverer is an automated, driverless vehicle. Each deliverer may have different requirements regarding the order in which the mail items are delivered. There may also be other individual requirements from delivery staff, such as the arrangement of particularly heavy mail items. These requirements can be taken into account by the system by providing the mail items accordingly at an output area.

Preferably, the output area can be designed to be displaceable relative to the gripping area. This is particularly advantageous if a large number of sub-areas are provided in the output area. For example, the output area can have a large number of end points, all of which are difficult to arrange in the gripping area. As a result, the gripping area can be relatively compact, whereas the system can sort the mail items into a large number of output sub-areas. For example, it is conceivable that different transport containers are provided to an output area on a conveyor, which are alternately moved into the gripping area by the conveyor as required by the system (i.e. in which output sub-area the currently handled mail item is to be arranged).

Preferably, the buffer area is designed to output at least one mail item based on the mail item information of the at least one mail item to the output area. In other words, the buffer area can additionally or alternatively actively output the mail items. It is conceivable here that the buffer area has various sub-compartments that can dispense mail items received therein at specific times. A compartment can represent a destination in the buffer area. The buffer area can be designed in a matrix form, for example. If a mail item is arranged in a sub-compartment of the buffer area, the sub-area can output the mail item in response to a command. It is conceivable here that the sub-compartments of the buffer area can output mail items individually through a flap in its base. The mail items can then be transported further by gravity. For example, the output area can be a movable area that can be moved back and forth below the buffer area. If a part of the output area is arranged below the buffer area, a command can be initiated that the sub-area of the buffer area releases a mail item, whereby the mail item can be fed to the output area. In one embodiment, an AGV can move back and forth under the buffer area and pick up the mail items from the buffer area in a desired order (i.e., in the aisle sequence). In this case, the output area can be realized by an AGV. Furthermore, a plurality of AGVs can realize the output area. The at least one AGV can travel individually or in a predetermined manner to the buffer area and the buffer area can actively feed a mail item to the AGV when the at least one AGV reaches a certain position. As a result, a greater throughput of mail items can be realized by the system.

Preferably, the gripping device comprises a robot. The robot can be realized by an automated gripper arm. At least one gripping device can be arranged on the gripper arm. The gripping device can be a mechanical gripper and/or a suction cup gripper. Furthermore, a large number of gripping devices can be arranged on the robot arm so that several mail items can be handled in parallel.

Preferably, the input area and/or the output area comprise a conveyor belt. As already described above, the input area can be defined by a conveyor belt, which is provided at least in sections in the gripping area. Similarly, the output area can be defined by a conveyor belt, which is arranged at least in sections in the gripping area.

Preferably, the input area can be designed in such a way that the at least one mail item can be provided in a transport container. This offers the advantage that the system can also handle mail items arranged in transport containers, such as boxes or the like, and sort them accordingly. This means that the system can also be used to transfer mail items to an automated handling system. In other words, the system is not dependent on mail items being fed by means of a conveyor belt or the like.

According to a further aspect of the present invention, a method for sorting mail items is provided. The method may comprise providing mail items at an input area. Further, mail item information of the provided mail items may be obtained or determined. Thereupon, the gripping device may move the mail items from the input area to a buffer area and move the mail items from the buffer area to an output area, at least one of them based on the mail item information. Alternatively or additionally, the mail items may be moved from the input area to the output area by the gripping device based on the mail item information.

In a preferred embodiment of the present invention, the gripping device can grip individual mail items from a box provided at the input area. The system can then identify the mail item via a barcode. The mail item can then be deposited in a buffer area (for example, a table or conveyor belt in the gripping area of the gripping device). As soon as the box in the input area is emptied or the buffer area is full, a sequence of the mail items handled so far can be determined based on the delivery aisle sequence (i.e. mail item information). The gripper can then pick up the items in the specified sequence and place them back in the box. The mail items can be placed in the same box from which they were removed. The mail items can also be placed in a separate transport box. In this case, a low requirement can be placed on the recognition of the mail items, as the deposit position is stored. In the case where the system places items in a large number of boxes or under storage areas, delivery must be made alternately from different boxes during a delivery journey. The deliverer can receive information about this digitally by the control unit outputting the position information.

The invention makes it possible to provide a robot pick-and-place system with an intermediate buffer for aisle sorting. Up to now, this has not been carried out with machine support, as the mail items in the smalls, parcels, bags, etc. area have individual dimensions and characteristics. The advantage of the present invention is that it requires less space than a conventional parcel sorter. Furthermore, pre-sorting can be carried out at night before the delivery staff start their shift. This can increase the efficiency of a delivery. Due to the expected increase in the volume of smaller consignments in view of the general e-commerce trend and ecological aspects through minimalist packaging, the volume of such consignments will increase. The system can also be used for a mixed range of parcels consisting of letters, smalls, bags, parcels, etc. It is also conceivable that the system can be used in a delivery base for other tasks, such as identifying consignments or rough sorting to a small number of end points.

Individual features or embodiments of the present invention can be combined with other features or other embodiments and thus form new embodiments. Embodiments and advantages mentioned in connection with the features or embodiments also apply analogously to the new embodiments. Advantages and embodiments mentioned in relation to the device also apply analogously to the method and vice versa.

### BRIEF DESCRIPTION OF THE DRAWINGS

In the following, the invention is described in detail based on the attached drawing.

FIG. 1 is a schematic illustration of the system according to one embodiment of the present invention; and

FIG. 2 is a flow chart illustrating a method according to one aspect of the present invention.

### DETAILED DESCRIPTION OF THE PREFERRED EMBODIMENTS

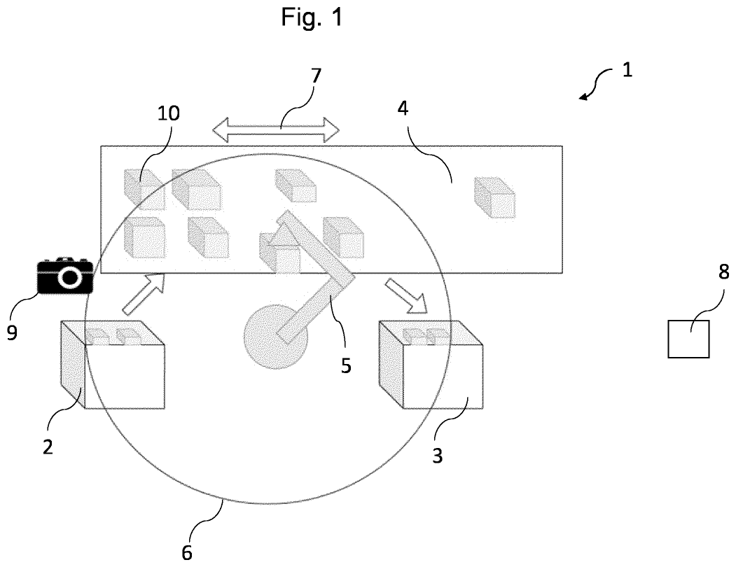

FIG. 1 schematically illustrates a system 1 according to one embodiment of the present invention. The system 1 comprises an input area 2 at which mail items 10 are provided.

In the present embodiment, a box with a plurality of mail items 10 is provided in or at the input area 2. Furthermore, the system 1 comprises a gripping device 5, which is designed to handle the mail items 10. The system 1 comprises a buffer area 4 in which the mail items 10 can be temporarily stored. The gripping device 5 can transfer the mail items 10 from the input area 2 to the buffer area 4. Furthermore, the system 1 comprises an output area 3, at which the mail items 10 can be output. In the present embodiment, a box is arranged in the output area 3, into which the mail items 10 are sorted. The gripping device 5 has a gripping area 6. In FIG. 1, the gripping area 6 is shown as a two-dimensional circle.

Nevertheless, the gripping area 6 is described by a three-dimensional sphere. The buffer area 4 is designed to be displaceable. More precisely, the buffer area 4 can be moved back and forth in the direction of movement 7 of the buffer area 4 (see FIG. 1). A control unit 8 can control the gripping device 5 and the movement of the buffer area 4. In this way, a parallel movement of the gripping device 5 and displacement of the buffer area 4 can be realized. Optionally, the control unit can check the position of the mail items on the buffer area 4 and/or the output area 3 if they are to be gripped from there. This check can be carried out using visual monitoring instruments, for example. Furthermore, the system 1 comprises a detection system 9, which is designed to optically detect mail items 10 that are picked up from the input area 2. The control unit 8 is designed to remove the mail items 10 from the input area 2 and/or the buffer area 4 in the sequence required by the aisle sequence of a deliverer and to provide them to the output area 3. In other words, system 1 can be used to realize an aisle sequence of randomly fed mail items 10 at the output area 3.

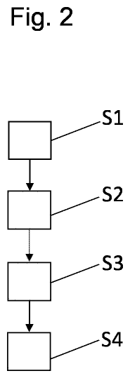

FIG. 2 shows a schematic flow chart of a method according to one embodiment of the present invention. In step S1, mail items 10 are provided at an input area 2. In a step S2, mail item information of the provided mail items 10 is obtained or determined. The mail item information is obtained by forwarding the mail item information from a higher-level system 1 upstream in the handling sequence of the mail items 10. The mail item information is determined by the recognition system 9 of the system 1. In this process, the mail item information can be obtained and/or determined. In this way, for example, it is possible to check mail item information that has already been predetermined. In step S3, the mail items 10 are moved from the input area 2 to the buffer area 4 by means of gripping device 5 and the mail items 10 are moved from the buffer area 4 to the output area 3, based on the mail item information. Additionally or alternatively, in a step S4, the mail items 10 are moved from the input area 2 to the output area 3 by means of the gripping device 5 based on the mail item information. This is the case if the mail items 10 are already present in the correct sequence in an input area 2 and therefore do not need to be stored temporarily. Due to the direct feed from the input area 2 to the output area 3, intermediate storage in the buffer area 4 is not necessary. This means that buffer area 4 can be used efficiently.

### LIST OF REFERENCE SIGNS

1 System
2 Input area
3 Output area
4 Buffer area
5 Gripping device
6 Gripping area
7 Direction of movement of the buffer area
8 Control unit
9 Recognition system
10 Mail item

1.-22. (canceled)

23. A system for sorting mail items, comprising:
an input area at which mail items can be fed to the system;
a buffer area configured to temporarily store at least one mail item;
at least one output area via which the mail items can be output from the system;
a gripping device configured to feed mail items in a gripping area of the gripping device from the input area to the buffer area and/or the output area; and
a control unit configured to control the gripping device in such a way that the at least one mail item is provided at the output area on the basis of at least one mail item information.

24. The system according to claim 23, wherein the output area is configured to provide a transport container into which the at least one mail item can be inserted by the gripping device.

25. The system according to claim 23, wherein the mail item information comprises a dimension of the mail item, an address information of the recipient, a weight of the mail item and/or a shipping information.

26. The system according to claim 23, wherein the control unit is configured to output position information for the mail item after a mail item has been fed to the output area by the gripping device.

27. The system according to claim 23, wherein the control unit is configured to control the gripping device such that at least one mail item can be sorted out based on one mail item information.

28. The system according to claim 23, further comprising:
a recognition system configured to recognize at least one mail item to obtain recognition information of the mail item.

29. The system according to claim 28, wherein the control unit is configured to assign mail item information to a mail item based on the recognition information of the mail item.

30. The system according to claim 28, wherein the recognition system is configured to detect the recognition information optically via a barcode on the mail item.

31. The system according to claim 23, wherein the buffer area is movable so that the buffer area can be displaced relative to the gripping area of the gripping device.

32. The system according to claim 31, wherein the buffer area comprises a turntable, a conveyor, a shelf and/or at least one pocket.

33. The system according to claim 23, wherein the buffer area is horizontally and/or vertically displaceable with respect to the direction of gravity.

34. The system according to claim 23, wherein the output area comprises at least one automated, driverless vehicle configured to transport away at least one mail item.

35. The system according to claim 23, wherein the gripping device is configured to feed at least one mail item from the buffer area and/or the output area to the input area.

36. The system according to claim 23, wherein the control unit is configured to control the gripping device such that the mail items are provided sorted according to their dimension in the buffer area and/or the output area.

37. The system according to claim 23, wherein the control unit is configured to control the gripping device such that the mail items are provided at the output area in an aisle sequence of a deliverer of the mail items.

38. The system according to claim 23, wherein the output area is configured to be displaceable relative to the gripping area.

39. The system according to claim 23, wherein the buffer area is configured to output at least one mail item to the output area based on the mail item information of the at least one mail item.

40. The system according to claim 23, wherein the gripping device comprises a robot.

41. The system according to claim 23, wherein the input area and/or the output area comprises a conveyor belt.

42. The system according to claim 23, wherein the input area is configured such that the at least one mail item can be provided in a transport container.

43. A method of sorting mail items, comprising:
providing mail items at an input area;
maintaining and/or determining mail item information of the provided mail items; and
moving the mail items via a gripping device from the input area to a buffer area and moving the mail items from the buffer area to an output area based on the mail item information, and/or moving the mail items from the input area to the output area via a gripping device based on the mail item information.

44. The method according to claim 43, wherein the gripping device grips individual mail items from a box provided at the input area.
